(19) United States
(12) Patent Application Publication
(10) Pub. No.: US 2008/0034903 A1
(43) Pub. Date: Feb. 14, 2008

(54) Device for Pressing on a Rack

(76) Inventor: Jans-Uwe Hafermalz, Waeschenbeuren (DE)

Correspondence Address: KENYON & KENYON LLP, ONE BROADWAY, NEW YORK, NY, 10004, US

(21) Appl. No.: 10/581,779

(22) PCT Filed: Dec. 1, 2004
(86) PCT No.: PCT/EP04/13597

§ 371 Date: May 14, 2007

(30) Foreign Application Priority Data
Dec. 5, 2003 (DE) 103-57-013.6
Feb. 12, 2004 (DE) 10-2004-006-935.2

(51) Int. Cl. F16H 55/28

(52) U.S. Cl. 74/89.19

(57) ABSTRACT

A device for pressing a rack onto a pinion includes a pressure piece and a stop element. A spring element that applies at least one of two successive stages of contact pressure, which press the pressure piece against the rack, is arranged between the pressure piece and the stop element. The pressure piece and the stop element are each provided with mutually aligned contact surfaces which are located at a distance from each other in a basic position. At least one of the contact surfaces is configured in a springy manner such that the second stage of contact pressure begins as soon as the contact surfaces enter in contact with one another.

### FIELD OF THE INVENTION

The present invention relates to a device for pressing a rack onto a pinion, having a pressure piece and a stop element.

The present invention also relates to a device for pressing a rack onto a pinion.

### BACKGROUND INFORMATION

A device of this type is described in German Published Patent Application No. 198 11 917.

Rack and pinion steering systems for motor vehicles usually have a steering housing, in which a rack is mounted such that it can be displaced longitudinally. A pinion which is mounted rotatably in the steering housing engages into the toothing of the rack and, when the steering column which is connected fixedly in terms of rotation to the pinion is rotated, brings about the lateral displacement of the rack, which in turn leads to pivoting of the steered wheels of the motor vehicle via track rods and steering knuckles. The engagement of the pinion into the rack is maintained without play by a pressure piece which bears against the rack opposite the pinion pressing the rack against the pinion under spring prestress. It is conventional for the pressure piece play to be set via a setting screw which in the process also influences the spring prestress.

Here, the pressure piece has to be designed such that or press against the rack such that coupling of the rack and the pinion can be maintained without play of the teeth which are in engagement with one another. Here, faults have to be taken into consideration with regard to the eccentricity of the pinion, its axial play and the wear of the teeth.

Furthermore, the mechanism has to be capable of enduring jolts which originate from the steered wheels when the latter strike an obstacle, for example.

German Published Patent Application No. 198 11 917 describes a coupling mechanism for a rack with respect to a pinion, which mechanism has a spring for pressing the pinion and the rack against one another, the spring being arranged for the purpose of exerting its action in accordance with at least two stages of pressure which follow one another. Here, the spring is configured as an elastomer which has at least two contact faces between the setting screw and the pressure piece. The fact that the pressure takes place at least in two stages achieves a situation where oscillations and jolts which tend to decouple the rack from the pinion and cause noise are damped to a pronounced degree, as the second stage of pressure replaces the first stage as soon as the oscillations or jolts exceed the capabilities of intervention of the first stage. In this manner, an increased pressing force is obtained, as a result of which the rack and the pinion are coupled in an improved manner and the noise which is produced is reduced.

However, a disadvantage may be the large tolerance of the spring force with small pressure piece play. The friction in the steering system is changed by the large tolerance, as a result of which the straight line stability behavior of the motor vehicle is influenced negatively. Moreover, it is a disadvantage that the spring force is relatively susceptible to temperature fluctuations. In addition to this, the spring force of the elastomer changes over its service life.

Firstly, it should be provided in the device for pressing a rack onto a pinion that the friction in the steering system is low when traveling in a straight line; secondly, a playfree toothing engagement should be ensured reliably during steering at great steering speeds. Moreover, the device should be as insusceptible as possible to temperature fluctuations and wear.

### SUMMARY

Example embodiments of the present invention may provide a device for pressing a rack onto a pinion, having a pressure piece and a stop element, which device may eliminate the above-mentioned disadvantages, may have, for example, very good damping properties with low wear, may prevent the occurrence of noise reliably and may be manufactured and assembled inexpensively.

Since the second stage of the pressure is carried out by contact faces of the pressure piece and the stop element which are in each case oriented toward one another coming into contact with one another, pressing which acts in at least two stages of the pressure piece onto the rack may be achieved. In a basic position, that is to say in a position in which no dynamic forces or forces as a result of the engagement of the pinion into the rack are active which are suitable for displacing the rack in the direction of the pressure piece, only the first stage of the pressure is active, that is to say the spring element which is arranged between the pressure piece and the stop element. In this position, the contact faces of the pressure piece and the stop element are situated at a distance from one another.

The spring prestress of the spring element results in a pressure piece play, in which only the spring element is active, that is to say the first stage of the pressure. The spring element may be manufactured within narrow tolerances in a conventional manner and therefore exerts a defined spring force on the rack. Satisfactory straight line traveling of the motor vehicle is possible as a result with a very small axial pressure piece play. As soon as large tooth separating forces or other forces which move the rack in the direction of the pressure piece occur during steering, the spring force of the spring element is overcome, as a result of which the contact face of the pressure piece makes contact with the contact face of the stop element. As a result of the fact that at least one contact face is of resilient configuration, the second stage of the pressure begins as soon as the contact faces make contact with one another. The second stage of the pressure or the contact face of resilient configuration may have a great spring force, as a result of which a playfree toothing engagement may be ensured when steering at large steering speeds. This playfree toothing engagement may reduce the development of noise during steering.

The resilient configuration of at least one of the contact faces begins to act only when the contact faces make contact with one another. Prior to this, the resilient contact face may be relieved of stress or the resilient contact face is stressed only by the contact.

The device hereof may have a long service life with an unchanged action. Moreover, in contrast to the device which is described in German Published Patent Application No. 198 917, the device hereof may be relatively insusceptible to temperature fluctuations. It may be provided that the pressure piece is formed from metal, e.g., aluminum, and the stop element may be formed from metal, e.g., steel. Moreover, it may be provided that the spring element is formed as a metallic helical spring.

The formation, e.g., of the pressure piece and the stop element from metal may make particularly exact manufacture possible with low tolerances. As a result, the pressure piece play, in which only the spring element is active which is arranged between the pressure piece and the stop element, may be kept particularly small, as a result of which the noise which is produced may be minimized.

As a result of the formation of the pressure piece, the stop element and the spring element from metal, the device has two metallic springs, e.g., the spring element which is clamped in and the at least one resilient contact face, which may have a long service life and are substantially independent with respect to temperature fluctuations. As a result, the friction in the steering system may be set exactly. The device hereof may be manufactured and assembled particularly simply and inexpensively.

The contact faces of the pressure piece and the stop element may bear against one another. Here, no noise may be produced as a result of the contact face of the pressure piece coming into contact with the contact face of the stop element. Here, it may be provided that the contact faces are prestressed against one another, in order to counteract wear which occurs or a seating process over the service life of the device. The prestressing of the contact faces may therefore achieve a situation where the contact faces still bear against one another even if, for example, the pinion is abraded on account of wear.

It may be provided that the pressure piece has a circumferential surface and a pin which protrudes in the direction of the stop element and the exposed end of which is configured as a contact face, and the stop element has an annular circumferential surface and an end wall which is configured as a contact face.

Here, the end wall of the stop element may be deflected in the basic position by the contact face of the pin. There may be provision here for the contact face of the stop element to be deflected by from 0.1 to 0.5 mm.

In order to generate a progressive spring characteristic diagram, there may be provision for the contact face of the pin to be of cambered configuration.

Example embodiments of the present invention are described in more detail below in the following description with reference to the appended Figures.

### BRIEF DESCRIPTION OF THE DRAWINGS

FIG. 1 is a cross-sectional view through a device according to an example embodiment of the present invention in a basic position, in an arrangement in which the contact faces are arranged at a distance from one another.

FIG. 2 is a cross-sectional view through the device in a basic position, in an arrangement in which the contact faces bear against one another.

FIG. 3 is a cross-sectional view through the device in a basic position, in an arrangement in which the contact faces bear against one another and a pin of the pressure piece is of resilient configuration.

FIG. 4 is a cross-sectional view through the device in a basic position, in an arrangement in which the contact faces bear against one another and both a pin of the pressure piece and an end wall of the stop element are of resilient configuration.

FIG. 5 is a partial cross-sectional view of the pressure piece.

### DETAILED DESCRIPTION

Rack and pinion steering mechanisms, e.g., for motor vehicles, having pressure pieces for coupling a rack with respect to a pinion are conventional, for which reason reference is made, for example, to German Published Patent Application No. 29 28 732 and German Published Patent Application No. 198 11 917.

Therefore, in the following text, only the features which are relevant will be discussed in greater detail. The basic principle of a coupling mechanism of this type for a rack and its drive pinion is also conventional and from the abovementioned documents.

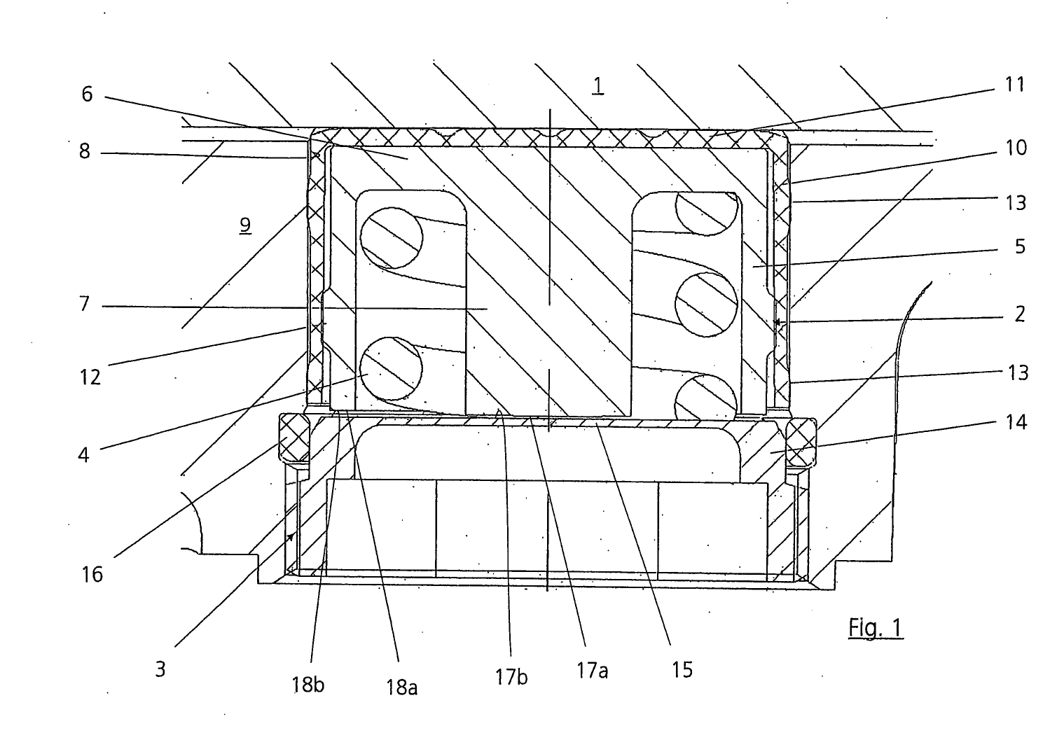

As can be seen from FIG. 1, the device hereof for pressing a rack 1 onto a pinion has a pressure piece 2 and a stop element 3. A spring element 4 which is configured as a compression spring is arranged between the pressure piece 2 and the stop element 3. Here, the spring element 4 exerts the first of at least two stages of the pressure which follow one another and press the pressure piece 2 against the rack 1.

The pressure piece 2 has an annular circumferential surface 5, a base part 6 which faces the rack 1, and a pin 7 which protrudes beyond the circumferential surface 5 in the direction of the stop element 3.

The pressure piece 2 may be formed from aluminum and manufactured by die casting.

As can be seen from FIG. 1, the pressure piece 2 is arranged in a receptacle space 8 of a steering housing 9. Here, the base part 6 of the pressure piece 2 is oriented in the direction of the rack 1. Here, the base part 6 has a profile which is adapted to the adjoining circumference of the rack 1. The receptacle space 8 in the steering housing 9 is usually configured as a cylindrical bore, the circumferential surface 5 of the pressure piece 2 being adapted substantially to the internal diameter of the receptacle bore 8.

In an example embodiment, the base part 6 which faces the rack 1 may be provided with a plastic insert which serves as a contact face for the rack 1. As an alternative, the base part 6 or the entire pressure piece 2 may also be configured from plastic.

In the exemplary embodiment, there is provision for the pressure piece 2 to be configured from metal, e.g., from aluminum, a sliding foil 10 being arranged between the inner wall of the receptacle space 8 and the circumferential surface 5 of the pressure piece 2. Here, the sliding foil 10 has a sliding base 11 as a bearing point for the rack 1. A plastic insert in the base part 6 or a similar friction reducing insert is therefore not necessary. The sliding foil 10 may be arranged in the receptacle space 8 by an interference fit. The sliding foil 10 or the sliding base 11 makes it possible, firstly, that the pressure piece 2 may transmit the required pressing force, and secondly the sliding base 11 forms a bearing surface which does not cause any significant frictional forces or wear during displacement of the rack 2.

Reference is made to German Patent Application No. 103 09 303.6 with regard to an arrangement of the sliding foil 10 and of the circumferential surface 5 of the pressure piece 2.

In the exemplary embodiment, there is provision for the pressure piece 2 to be arranged in the sliding foil 10 or to be connected to the latter by an interference fit. In a simple manner, this may be realized by an external diameter of the circumferential surface 5 of the pressure piece 2, which external diameter is greater than the internal diameter of the sliding foil 10. In the exemplary embodiment, however, the circumferential surface 5 has a ring 12. Here, the interference fit is between the external diameter of the ring 12 of the circumferential surface 5 and the internal diameter of the sliding foil 10.

The interference fit between the sliding foil 10 and the inner wall of the receptacle space 8 takes place in an analogous manner between the pressure piece 2 and the sliding foil 10. For this purpose, the sliding foil 10 has circumferential sliding foil rings 13 which have an external diameter which is greater than the diameter of the receptacle space 8. The sliding foil 10 may have, for example, a wall thickness of, e.g., 1 mm, the sliding foil 10 being configured more thickly in the region of the sliding foil rings 13, with the result that the wall thickness is, for example, from 1.1 mm to 1.5 mm, e.g., 1.2 mm.

Furthermore, as can be seen from FIG. 1, the receptacle bore 8 is closed by the stop element 3 at its opening which faces away from the rack 1. In the exemplary embodiment illustrated, the stop element is configured as a setting screw 3 which is screwed into the receptacle bore 8 in a defined manner. Here, the setting screw 3 has an annular circumferential surface 14 and an end wall 15. The setting screw 3 may be formed from steel and may be manufactured by deep drawing.

A sealing ring 16 may be provided for sealing between 5 the inner wall of the receptacle space 8 and the setting screw 3.

As can be seen from FIG. 1, the spring element 4 is configured as a helical spring which is arranged substantially within a hollow space formed by the circumferential surface 5 of the pressure piece 2 and is clamped between the base part 6 of the pressure piece 2 and the end wall 15 of the setting screw 3.

The pressure piece 2 and the setting screw 3 in each case have contact faces 17a, 17b which are oriented toward one another and are arranged at a distance from one another in a basic position. Here, at least one of the contact faces 17a, 17b is of resilient configuration, with the result that the second stage of the pressure begins as soon as the contact faces 17a, 17b make contact with one another. In the exemplary embodiment illustrated, the contact face 17a of the pressure piece 2 is formed by the exposed end of the pin 7 which protrudes beyond the circumferential surface 5 of the pressure piece 2 in the direction of the setting screw 3. Here, the pin 7 extends coaxially with respect to the axis of the pressure piece 2 and is located in the center of the helical spring 4 and is surrounded by the latter. The pin 7 is configured in one piece with the pressure piece 2. The contact face 17a may be formed from aluminum.

In the exemplary embodiment illustrated, there is provision for the contact face 17b of the setting screw 3 to be formed by the end wall 15. In the exemplary embodiment illustrated, furthermore, there is provision for the contact face 17b or the end wall 15 to be of resilient configuration. Here, the wall thickness of the end wall may be, for example, from 0.6 to 0.9 mm, e.g., 0.7 mm. The end wall 15 or the contact face 17b may deflect accordingly, as a result of this arrangement or as a result of the fact that there is a clearance behind the end wall 15.

The contact face 17b is set by screwing in the setting screw 3. The pressure piece play or the distance between the contact face 17a and the contact face 17b results from the spring prestress of the helical spring 4 which is supported on the setting screw 3, which is screwed into the receptacle space 8, and, on the other side, presses the pressure piece 2 against the sliding foil 10 or the sliding base 11 and thus the rack 1 against the pinion (which is mounted in the steering housing 9). Only the spring force of the helical spring 4 acts before the contact face 17a makes contact with the contact face 17b or while the distance is being overcome between the contact face 17a and the contact face 17b. As soon as the spring force of the helical spring 4 has been overcome and the contact face 17a has made contact with the contact face 17b, the resilient configuration of the setting screw 3 becomes active. In order to limit the spring travel of the contact face 17b or to define a second pressure piece play while the second stage of the pressure is active, the pressure piece 2 and the setting screw 3 each have a second contact face 18a, 18b which are oriented toward one another and, in the basic position, are at a distance from one another which is greater than the distance between the first contact faces 17a, 17b. The second contact face 18a of the pressure piece 2 and the second contact face 18b of the setting screw 3 therefore serve as end stops for the movement of the pressure piece 2 in the direction of the setting screw 3. The second pressure piece play is thus defined fixedly by the components, that is to say the pressure piece 2 and the setting screw 3, and is realized by the contact faces 18a, 18b.

The contact face 18b of the setting screw 3 introduces the forces directly into the steering housing 9 without a spring action. While the second pressure piece travel is being covered, that is to say after the contact face 17a has made contact with the contact face 17b, the force which occurs at the strut is stored in the resilient setting screw 3 and thus returned again during steering. As a result, a playfree toothing engagement may also be ensured at high steering speeds. The high spring rate of the setting screw 3 stores a large spring force in the second pressure piece travel having narrow tolerances. The playfree toothing engagement which results from this may reduce the noise development during steering.

As can be seen from FIG. 1, the second contact face 18a of the pressure piece 2 is formed by the exposed end, which is oriented in the direction of the setting screw 3, of the circumferential surface 5 of the pressure piece 2. The second contact face 18b of the setting screw 3 is formed by the end, which is oriented in the direction of the pressure piece 2, of the annular circumferential surface 14 of the setting screw 3.

In order to attain a progressive spring rate at the setting screw 3 or the contact face 17b of the setting screw 3, it may be provided for the contact face 17a to be of cambered configuration. That is to say, the contact face 17a may be configured as a curved surface, for example, having a radius of from 100 to 300 mm, e.g., 200 mm. Here, the radius of the contact face 17a may be adapted to the wall thickness of the end wall 15, with the result that the stresses which occur in the end wall 15 or the setting screw 3 may be controlled. A further aspect of the cambered refinement of the contact face 17a consists in that the pressure piece 2 may thus be oriented satisfactorily on the rack 1 and is not overgoverned by the contact with the contact face 17b.

The spring rate of the helical spring 4 may be, for example, from 200 to 350 N/mm, e.g., 280 N/mm. The spring rate of the setting screw 3 or of the contact face 17b may be, for example, from 1,000 to 25,000 N/mm and rise to a spring force of from 2,500 N to 3,500 N over a spring travel of 0.2 mm.

The spacing between the first contact face 17a of the pressure piece 2 and the first contact face 17b of the setting screw 3 in the basic position may be, for example, from 0.02 mm to 0.1 mm, e.g., 0.05 mm. The spacing between the second contact face 18a of the pressure piece 2 and the second contact face 18b of the setting screw 3 in the basic position may be, for example, from 0.15 mm to 0.3 mm, e.g., 0.2 mm.

The device hereof may be suitable for rack and pinion steering systems for motor vehicles, but it is not restricted thereto. The device may also be used in rack and pinion steering systems in other fields.

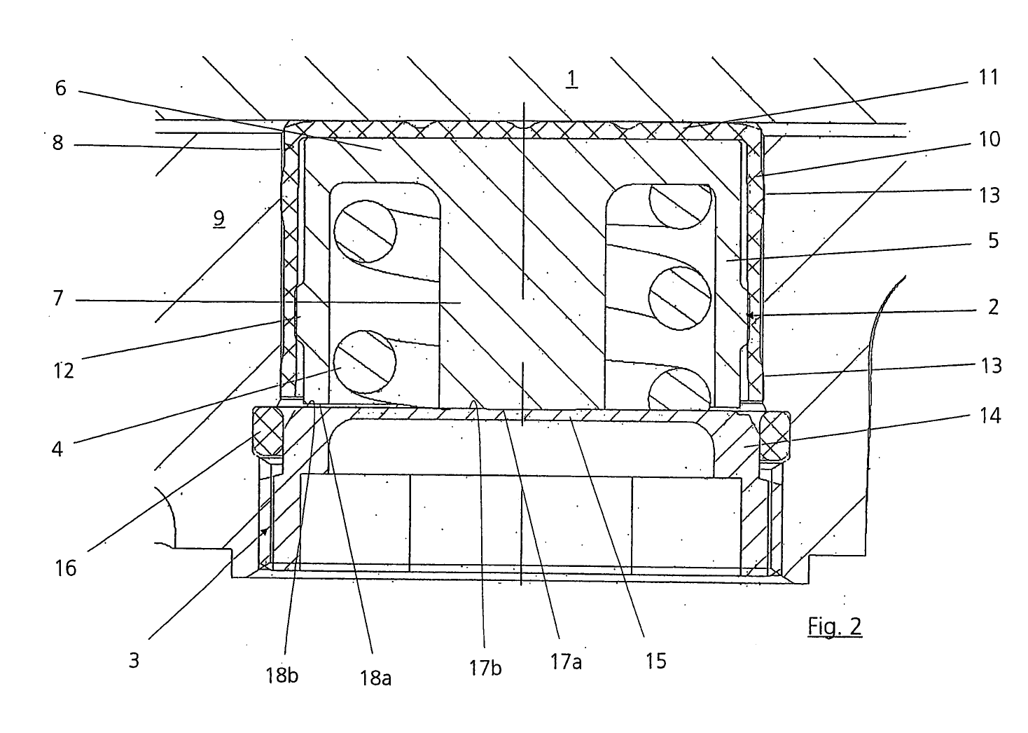

FIGS. 2 to 5 show alternative embodiments to that illustrated in FIG. 1. The parts which are denoted by the same designations in FIG. 1 and FIGS. 2 to 5 correspond to one another, as long as changes are not referred to in the following text, so that a further description of these parts with regard to FIGS. 2 to 5 is omitted.

FIG. 2 illustrates an example embodiment, in which the contact faces 17a, 17b bear against one another in a basic position. Here, there is provision for the contact face 17b of the stop element 3 to be deflected by the contact face 17a of the pin 7 in the basic position. Here, there may be provision for the contact face 17b to be deflected by from 0.1 to 0.5 mm in the basic position.

In accordance with FIG. 2, there is provision for the contact face 17a of the pin 7 to be of cambered configuration in order to generate a progressive spring characteristic diagram.

The distance between the contact faces 18a and 18b may be from 0.05 mm to 0.3 mm, e.g., 0.1 mm, in the basic position.

The use of a spring 4 may also be dispensed with.

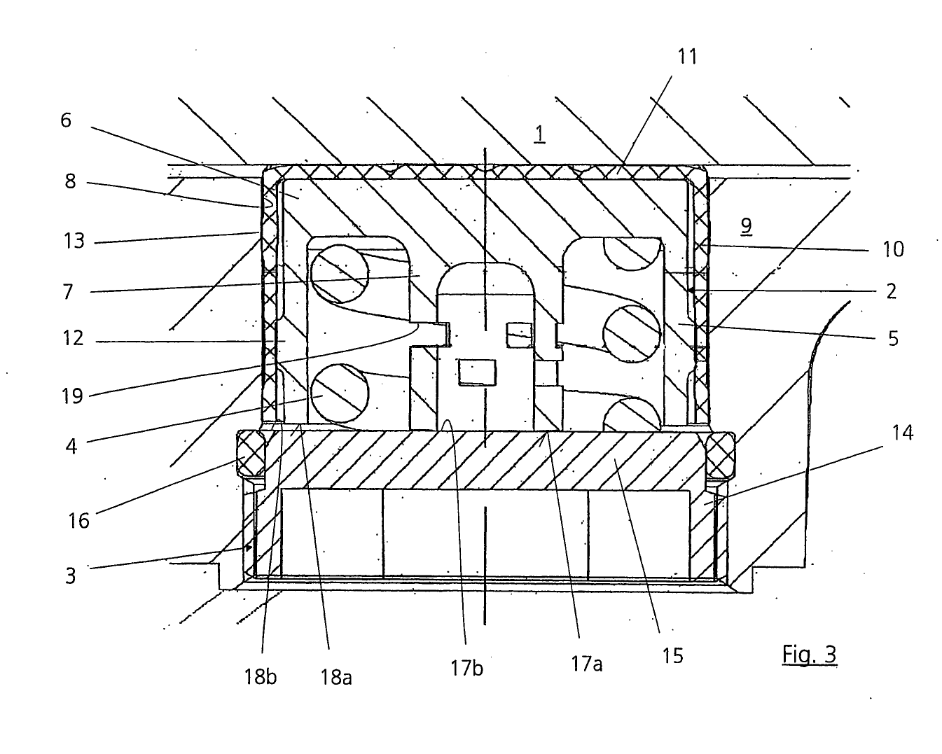

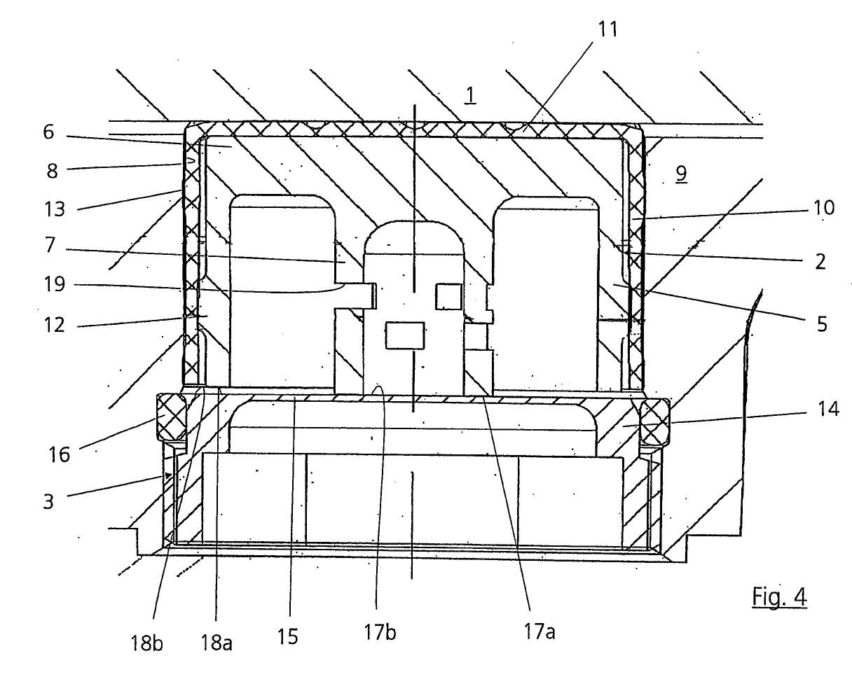

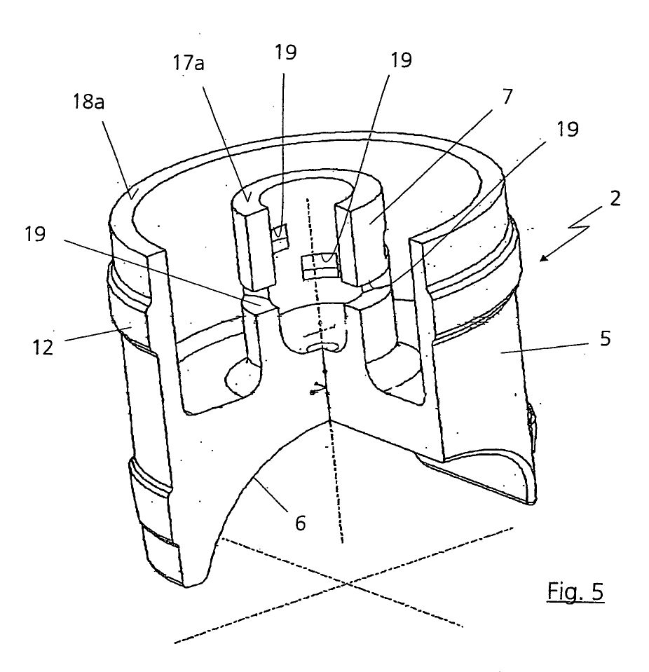

FIG. 3 illustrates an example embodiment, in which the contact faces 17a, 17b bear against one another in a basic position. Here, in contrast to FIG. 2, there is provision for the pin 7 to be of resilient configuration. In accordance with FIG. 3, the end wall 15 is of rigid or substantially rigid configuration. The pin 15 is provided with cutouts 19 which are arranged offset with respect to one another or with notches which lead to the resilient configuration of the pin 7. Here, as also results from FIGS. 4 and 5, the cutouts 19 are arranged offset with respect to one another both in the axial direction of the pin 7 and along the circumference of the pin 7. In the exemplary embodiment, the cutouts 19 extend over approximately ⅛-¼ of the circumference of the pin. This may be particularly suitable, and the cutouts 19 may also be arranged in a different manner in the pin 7 and may have a length which differs from the exemplary embodiment.

As an alternative to a resilient configuration of the pin 7 by the introduction of cutouts 19, there may also be provision, for example, for the pin 7 to be of thin configuration, such that the result is a resilient action. A further possibility of achieving a resilient configuration of the pin 7 may consist in that, for example, the latter is configured partially or completely from a material (modulus of elasticity) which has a desired elasticity. Accordingly, conventional plastics may be used, for example, for this purpose.

A resilient configuration of the pin 7 may be achieved in a particularly simple manner by the introduction of cutouts 19.

In accordance with FIG. 3, the resilient configuration of the device results substantially from the resilient configuration of the pin 7. In the example embodiment which is illustrated as an alternative in FIG. 4, the end wall 15 also has a resilient configuration, with the result that the resilient action of the device results both from the pin 7 and from the end wall 15. Here, in accordance with FIG. 4 in an analogous manner to FIG. 2, there may be provision for the pin 7 and the end wall 15 to already be deflected in a basic position. The prestressing of the contact faces 17a, 17b of the pin 7 and the end wall 15, respectively, achieves the situation where the contact faces 17a, 17b still bear against one another when the pinion, for example, is abraded on account of wear.

FIG. 4 illustrates an arrangement, in which the use of a spring element 4 has been dispensed with. The use of a spring 4 may also be dispensed with in the example embodiment in accordance with FIG. 3 if this appears expedient for the provided application.

FIG. 5 illustartes the pressure piece 2 with a quarter cut away.

In an analogous manner to FIG. 2, there may be provision, in accordance with FIGS. 3 to 5, for the spacing between the contact faces 18a and 18b to be from 0.05 mm to 0.3 mm, e.g., 0.1 mm, in the basic position.

The device is not restricted to the arrangements illustrated. Further possible embodiments or combinations result, e.g., from surveying FIGS. 1 to 5 together.

### LIST OF REFERENCE CHARACTERS

1 Rack
2 Pressure piece
3 Stop element, setting screw
4 Spring element
5 Annular circumferential surface
6 Base part
7 Pin
8 Receptacle space
9 Steering housing
10 Sliding foil
11 Sliding base
12 Ring
13 Sliding foil rings
14 Annular circumferential surface
15 End wall
16 Sealing ring
17 a, b First contact face
18 a, b Second contact face
19 Cutouts

1-25. (canceled)

26. A device for pressing a rack onto a pinion, comprising:
a pressure piece;
a stop element,
a spring element arranged between the pressure piece and the stop element, the spring element adapted to exert a first stage of at least two stages of pressure which follow one another and press the pressure piece against the rack, the pressure piece and the stop element including first contact faces oriented toward one another and are arranged at a distance from one another in a basic position;
wherein the pressure piece and the stop element are formed from metal, the first contact face of the stop element is of resilient configuration, a second stage of the two stages of pressure beginning as soon as the first contact faces make contact with one another, and
wherein the pressure piece and the stop element each have a second contact face which are oriented toward one another and, in the basic position, are at a distance from one another which is greater than the distance of the first contact faces from one another, the second contact faces configured to represent an end stop for movement of the pressure piece.

27. The device according to claim 26, wherein the pressure piece includes a circumferential surface and a pin that protrudes in a direction of the stop element, an exposed end of the pin configured as a contact face.

28. The device according to claim 27, wherein the pin extends coaxially with respect to an axis of the pressure piece.

29. The device according to claim 26, wherein the stop element includes an annular circumferential surface and an end wall configured as a contact face.

30. The device according to claim 29, wherein the spring element is arranged substantially within a hollow space of the pressure piece and is clamped between a base part of the pressure piece and the end wall of the stop element.

31. The device according to claim 30, wherein the spring element is arranged as a helical spring, in a center of which the pin, starting from the base part of the pressure piece, extends in a direction of the end wall.

32. The device according to claim 26, wherein the pin is arranged in one piece with the pressure piece.

33. The device according to claim 26, wherein the distance between the first contact face of the pressure piece and the first contact face of the stop element is one of (a) between 0.02 mm and 0.1 mm and (b) 0.05 mm in the basic position.

34. The device according to claim 26, wherein the distance of the second contact face of the pressure piece from the second contact face of the stop element is one of (a) between 0.15 mm and 0.3 mm and (b) 0.2 mm in the basic position.

35. The device according to claim 27, wherein the exposed end, oriented in a direction of the stop element, of the circumferential surface of the pressure piece is arranged as a second contact face.

36. The device according to claim 30, wherein an end, which is oriented in a direction of the pressure piece, of the annular circumferential surface of the stop element is arranged as a second contact face.

37. The device according to claim 26, wherein the pressure piece is arranged in a receptacle space of a steering housing, a sliding foil arranged between an inner wall of the receptacle space and a circumferential surface of the pressure piece.

38. The device according to claim 37, wherein the sliding foil includes a sliding base as a bearing point for the rack.

39. The device according to claim 37, wherein the sliding foil is arranged in the receptacle space by an interference fit.

40. The device according to claim 37, wherein the stop element is arranged as a setting screw screwable into the receptacle space.

41. A device for pressing a rack onto a pinion, comprising:
a pressure piece; and
a stop element, the pressure piece and the stop element having contact faces which are oriented toward one another;
wherein the pressure piece and the stop element are formed from metal, the pressure piece and the stop element having first contact faces oriented toward one another and bear against one another in a basic position, the first contact face of the stop element of resilient configuration, the pressure piece and the stop element having a second contact faces oriented toward one another and, in the basic position, are at a distance from one another and are configured to represent an end stop for movement of the pressure piece.

42. The device according to claim 41, wherein the pressure piece includes a circumferential surface and a pin that protrudes in a direction of the stop element, an exposed end of the pin arranged as a contact face.

43. The device according to claim 41, wherein the pin extends coaxially with respect to an axis of the pressure piece.

44. The device according to claim 41, wherein the stop element includes an annular circumferential surface and an end wall arranged as a contact face.

45. The device according to claim 44, wherein the first contact face of the stop element is one of (a) deflected and (b) clamped in the basic position by the first contact face of the pin.

46. The device according to claim 42, wherein the contact face of the pin is of cambered configuration to generate a progressive spring characteristic diagram.

47. The device according to claim 42, wherein the pin is arranged in one piece with the pressure piece.

48. The device according to claim 42, wherein the exposed end, which is oriented in the direction of the stop element, of the circumferential surface of the pressure piece is arranged as a second contact face.

49. The device according to claim 42, wherein an end, which is oriented in the direction of the pressure piece, of the annular circumferential surface of the stop element is arranged as a second contact face.

50. The device according to claim 41, wherein the stop element is arranged as a setting screw.
